(19) United States
(12) Patent Application Publication
(10) Pub. No.: US 2009/0010413 A1
(43) Pub. Date: Jan. 8, 2009

(54) Information processing apparatus

(75) Inventor: Yasuhiko Abe, Saitama-Ken (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/070,294

(22) Filed: Feb. 14, 2008

(30) Foreign Application Priority Data
Mar. 22, 2007 (JP) P2007-075666

(51) Int. Cl. H04M 3/42

(52) U.S. Cl. 379/210.01

(57) ABSTRACT

An information processing apparatus includes a storage unit for storing a state information set by a first program and a callback information set by a second program, which are associated with each other, a detection unit for detecting a change in the state information set by the first program, an acquisition unit for acquiring the callback information set by the second program if the detection unit detects the change in the state information set by the first program, and an execution unit for calling a callback on the basis of the callback information acquired by the acquisition unit.

### BACKGROUND OF THE INVENTION

1. Field of the Invention

The present invention relates to an information processing apparatus for managing the state of a plurality of programs and causing another program to operate in accordance with a change in the state of an arbitrary one of the programs.

2. Related Art

Currently, a variety of processes have been performed with an information processing apparatus provided with a plurality of functions. At a time of causing the variety of functions to operate in the information processing apparatus, for example, causing the information processing apparatus to operate in connection with hardware items such as a display and an antenna, it is necessary to establish communication between a hardware-controlling portion and a software-controlling portion. In this case, each of the hardware items to be connected requires an interface, which makes it difficult to cause the respective hardware items to operate in conjunction with one another.

In view of the above matters, an electronic device has been proposed which causes the respective hardware items to operate in conjunction with one another. For example, Japanese Unexamined Patent Application Publication No. 2006-134187 describes an electronic device which performs rational display processing on a plurality of displays. The electronic device includes a regulation unit for regulating display processes on a plurality of displays in a batch manner. Since the regulation unit controls the display processes on the basis of a previously specified priority, an irrational display operation is prevented.

At a time of connecting a plurality of hardware items to an information processing apparatus, it is necessary to combine a process of detecting a change in the state of each of the hardware items (e.g., a process performed by a driver) with a process performed in accordance with the change in the state (e.g., a process performed by a GUI). Usually, it is necessary to describe a required process in either one of the two processes. If the driver is changed, therefore, it is necessary to have a resultant difference absorbed in the GUI, or to recreate the driver to suit the system.

### SUMMARY OF THE INVENTION

In light of the above circumstances, it is an object of the present invention to provide an information processing apparatus which includes effective middleware between two processes, i.e., a process of detecting a change in the state of hardware and a process performed in accordance with the change in the state, so as to increase a program reuse rate irrespective of a change of a driver.

To achieve the above object, there is provided an information processing apparatus for executing a plurality of programs, which includes a storage unit, a detection unit, an acquisition unit, and an execution unit. The storage unit stores a state information set by a first program and a callback information set by a second program, with the state information and the callback information associated with each other. The detection unit detects a change in the state information set by the first program. The acquisition unit acquires the callback information set by the second program if the detection unit detects the change in the state information set by the first program. The execution unit calls a callback on the basis of the callback information acquired by the acquisition unit.

The information processing apparatus according to the above aspect may increase the program reuse rate irrespective of the change of a driver due to the inclusion of the effective middleware between the two processes, i.e., the process of detecting a change in the state of hardware and the process performed in accordance with the change in the state.

In a preferred embodiment of the above aspect, it may be desired that a group including the mutually associated state information and callback information is managed with an ID unique to the group, and information of a plurality of groups is stored by the storage unit.

The storage unit may store a battery level information as the state information and to store a program for notifying of a battery level as the callback information, and the execution unit may notify the battery level on the basis of the callback information.

The storage unit may store charging start information as the state information and to store a program for performing a charging process as the callback information, and the execution unit may perform the charging process on the basis of the callback information.

The storage unit may store radio field intensity information for communication as the state information and to store a program for calculating an antenna level as the callback information, and the execution unit may calculate the antenna level on the basis of the callback information.

The nature and the further characteristic features of the embodiments may be made clearer from the following descriptions made with reference to the accompanying drawings.

### BRIEF DESCRIPTION OF THE DRAWINGS

In the accompanying drawings:

FIGS. 1A and 1B are views showing an outer appearance of an information processing apparatus according to an embodiment of the present invention;

FIGS. 2A and 2B are views showing an outer appearance of the information processing apparatus according to the embodiment of the present invention;

FIG. 3 is a diagram showing functional configuration of the information processing apparatus according to the embodiment of the present invention;

FIG. 4 is a diagram showing software configuration of middleware of the information processing apparatus according to the embodiment of the present invention;

FIG. 5 is a conceptual diagram for explaining a process performed by the information processing apparatus according to the embodiment of the present invention;

FIG. 6 is a flowchart illustrating a procedure of the process performed by the information processing apparatus according to the embodiment of the present invention;

FIG. 7 is a conceptual diagram for explaining a terminal state monitoring process performed by the information processing apparatus according to the embodiment of the present invention;

FIG. 8 is a flowchart illustrating a procedure of the terminal state monitoring process performed by the information processing apparatus according to the embodiment of the present invention;

FIG. 9 is a conceptual diagram for explaining a battery level monitoring process performed by the information processing apparatus according to the embodiment of the present invention;

FIG. 10 is a flowchart illustrating a procedure of the battery level monitoring process performed by the information processing apparatus according to the embodiment of the present invention;

FIG. 11 is a conceptual diagram for explaining a charging control process performed by the information processing apparatus according to the embodiment of the present invention;

FIG. 12 is a flowchart illustrating a procedure of the charging control process performed by the information processing apparatus according to the embodiment of the present invention;

FIG. 13 is a conceptual diagram for explaining an antenna level monitoring process performed by the information processing apparatus according to the embodiment of the present invention;

FIG. 14 is a flowchart illustrating a procedure of the antenna level monitoring process performed by the information processing apparatus according to the embodiment of the present invention;

FIG. 15 is a conceptual diagram for explaining an inside/outside-range state monitoring process performed by the information processing apparatus according to the embodiment of the present invention;

FIG. 16 is a flowchart illustrating a procedure of the inside/outside-range state monitoring process performed by the information processing apparatus according to the embodiment of the present invention;

FIG. 17 is a conceptual diagram for explaining an inside/outside-range state monitoring process performed by the information processing apparatus according to the embodiment of the present invention; and

FIG. 18 is a flowchart illustrating a procedure of the inside/outside-range state monitoring process performed by the information processing apparatus according to the embodiment of the present invention.

### DESCRIPTION OF THE PREFERRED EMBODIMENTS

With reference to the accompanying drawings, description will be made of an embodiment of an information processing apparatus according to the present invention.

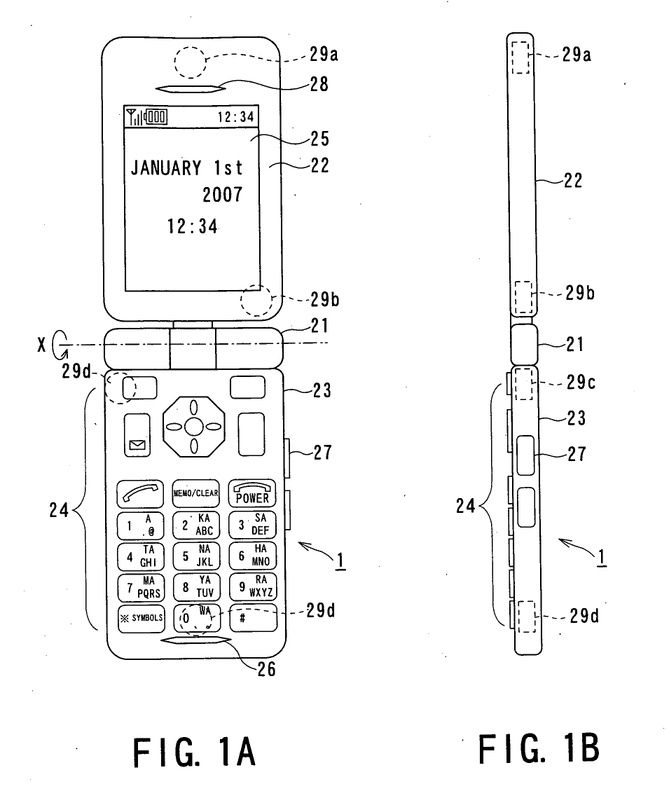

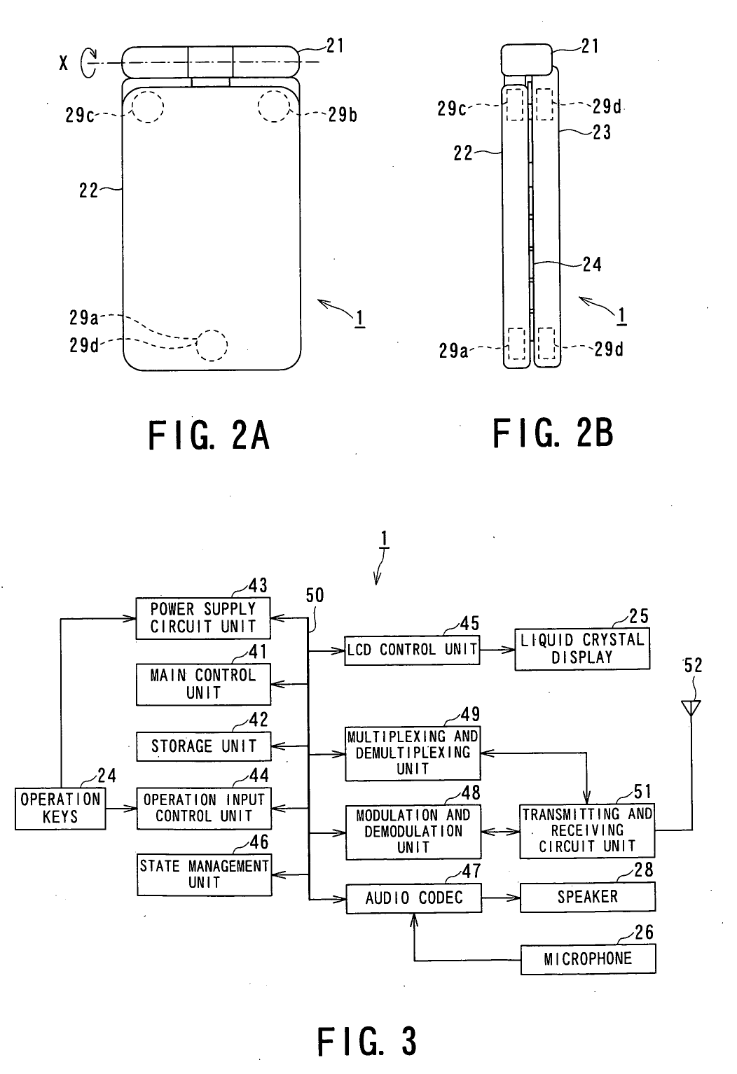

FIGS. 1A and 1B and FIGS. 2A and 2B illustrate a folding mobile phone device used for explanation as an example of the information processing apparatus 1. FIG. 1A is a front view of the information processing apparatus 1 opened to approximately 180 degrees, and FIG. 1B is a side view of the opened information processing apparatus 1. Meanwhile, FIG. 2A is a front view of the folded information processing apparatus 1, and FIG. 2B is a side view of the folded information processing apparatus 1.

As illustrated in FIGS. 1A and 1B and FIGS. 2A and 2B, in the information processing apparatus 1, a first casing 22 and a second casing 23 are hinge-connected with a hinge portion 21 therebetween in the center of the apparatus. Thus, the information processing apparatus 1 is configured to be foldable by means of the hinge portion 21 in an X direction indicated in FIGS. 1A and 2A. At a predetermined position inside the information processing apparatus 1, a transmitting and receiving antenna (an antenna 52 illustrated in FIG. 3 later described) is provided. Through the built-in antenna 52, the information processing apparatus 1 transmits and receives radio waves to and from a base station, not shown.

A central portion of the first casing 22 is provided with a liquid crystal display 25. An upper portion of the liquid crystal display 25 displays, for example, an antenna pictograph indicating a current antenna level of the antenna 52, a battery pictograph indicating a current battery level or a current charging state of the information processing apparatus 1, a current time, and so forth. Further, in the reception of terrestrial digital broadcasts, a central portion of the liquid crystal display 25 displays moving images of the terrestrial digital broadcasts.

Further, at a predetermined position above the liquid crystal display 25, a speaker 28 is provided to enable a user to listen to the sound therefrom.

A surface of the second casing 23 is provided with operation keys 24, which include numeric keys representing numbers 0 to 9, a call key, a redial key, a call-end and power key, a clear key, an electronic mail key, and so forth. Using the operation keys 24, a user can input a variety of instructions. Further, an upper portion of the second casing 23 is provided with a cross key and a confirmation key, which constitute the operation keys 24. Through the operation of the cross key by the user in the vertical and horizontal directions, the user can move an assigned cursor in the vertical and horizontal directions.

The second casing 23 is provided with a microphone 26 below the operation keys 24 so that the microphone 26 collects the sound of the user in a call.

Further, the second casing 23 is provided with a battery pack, not shown, attached and inserted in the back surface thereof. When the call-end and power key is turned on, electric power is supplied from the battery pack to respective circuit units to bring the circuit units into an operational state.

Further, magnetic sensors 29a, 29b, 29c, and 29d are provided at predetermined positions inside the first and second casings 22 and 23 to detect the open or closed state of the information processing apparatus 1.

FIG. 3 is a functional configuration diagram of the information processing apparatus 1. As illustrated in FIG. 3, the information processing apparatus 1 is configured to include a main control unit 41, a storage unit 42, a power supply circuit unit 43, an operation input control unit 44, an LCD control unit 45, a state management unit 46, an audio codec 47, a modulation and demodulation circuit unit 48, and a multiplexing and demultiplexing unit 49, which are connected to one another by a bus 50.

The main control unit 41 includes a CPU (Central Processing Unit) for performing a variety of data processing and arithmetic operations. The storage unit 42 includes a magnetic storage device, such as a hard disk and a ROM (Read Only Memory) for storing a processing program and so forth performed by the main control unit 41, and an electrical storage device, such as a RAM (Random Access Memory) for temporarily storing data used in the processing performed by the main control unit 41. The main control unit 41 further includes therein a timer for measuring a current date and time.

The power supply circuit unit 43 switches the ON-OFF state of a power supply on the basis of an input by the user through the operation keys 24. In an “ON” state of the power supply, the power supply circuit unit 43 supplies electric power from an electric power supply source (e.g., a battery) to the respective units to bring the information processing apparatus 1 into an operational state.

The operation input control unit 44 transmits data input through the operation keys 24 to the main control unit 41.

The LCD control unit 45 performs a process of displaying image data on the liquid crystal display (a main display) 25 on the basis of the control by the main control unit 41.

The state management unit 46 performs a state management process of monitoring the state of a plurality of programs and calling, in accordance with a change in the state of an arbitrary one of the programs, a callback in another program.

The audio codec 47 generates a digital audio signal from the sound collected by the microphone 26, on the basis of the control by the main control unit 41. In an audio call, the digital audio signal is input from the audio codec 47 to the modulation and demodulation circuit unit 48. Then, the modulation and demodulation circuit unit 48 transmits the digital audio signal to a transmitting and receiving circuit unit 51. The transmitting and receiving circuit unit 51 transmits the digital audio signal through the antenna 52.

Further, the modulation and demodulation circuit unit 48 receives an input of a digital audio signal received by the transmitting and receiving circuit unit 51 through the antenna 52. In an audio call, the audio codec 47 acquires the digital audio signal, converts the digital audio signal into an analog audio signal, and outputs the analog audio signal from the speaker 28 as the sound.

The multiplexing and demultiplexing unit 49 performs a multiplexing process of multiplexing a plurality of signals to generate a multiplexed signal and also performs a demultiplexing process of demultiplexing a multiplexed signal into a plurality of signals.

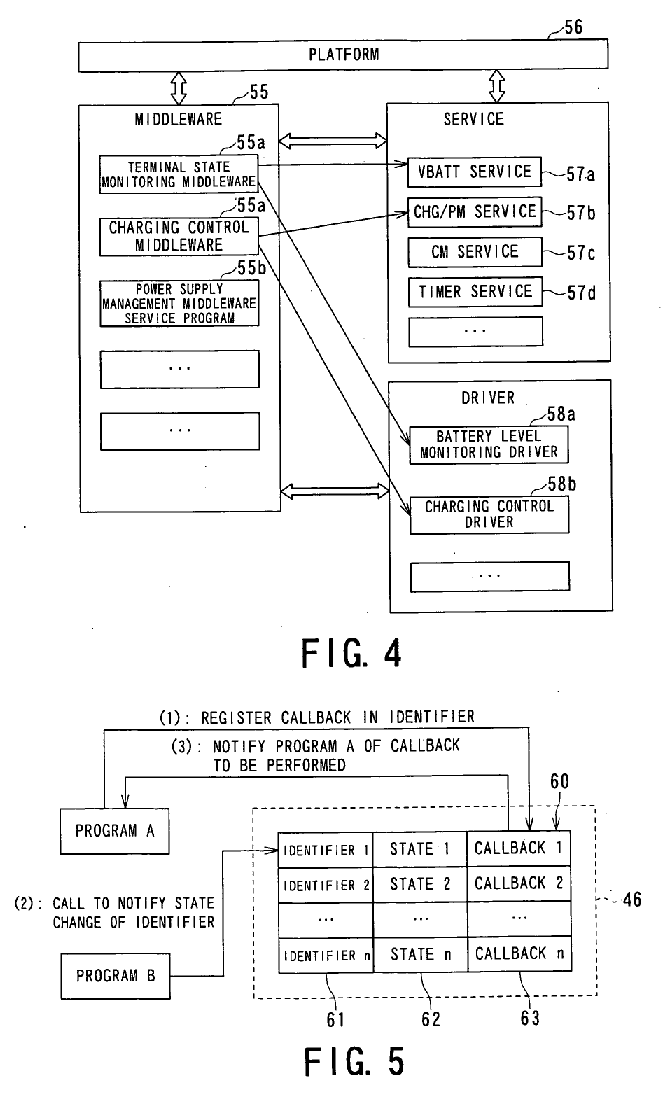

FIG. 4 illustrates a software configuration diagram of middleware 55, of the information processing apparatus 1. The middleware 55 of the information processing apparatus 1 includes terminal state monitoring middleware 55a for performing a terminal state monitoring process (see the first embodiment) later described, and power supply management middleware 55b for managing, for example, the state of charging when the charging is performed. The middleware 55 is connected to a platform 56.

The information processing apparatus 1 includes a service program 57 including a VBATT service 57a for determining a remaining battery charge, a CHG/PM service 57b for controlling and determining, for example, the charging and an interrupt in the charging, a CM service 57c for measuring an electric field intensity, a TIMER service 57d for counting the time, and so forth.

The information processing apparatus 1 further includes a driver 58 for each hardware item, and has a function of controlling the hardware item when the hardware item is connected to the information processing apparatus 1. The information processing apparatus 1 includes, as the driver 58, a battery level monitoring driver 58a for controlling a battery of the power supply circuit unit 43, a charging control driver 58b for performing a control operation in the charging, a driver for controlling the antenna 52, and so forth, for example.

In the information processing apparatus 1, the middleware 55, the service program 57, and the driver 58 are connected to one another so as to be operated in conjunction with one another through mutual communication. The state management unit 46 corresponds to the middleware 55 of FIG. 4, and performs the state management process of managing the state of each of the service program 57 and the driver 58.

With reference of a conceptual diagram illustrated in FIG. 5, the state management process performed by the image processing apparatus 1 will now be described.

The storage unit 42 stores programs A and B which represent a program of the driver, a program of the middleware, and so forth.

The state management unit 46 stores a state management table 60 which stores information representing the state of the program B and a callback to the program A called in the state of the program B. As illustrated in FIG. 5, the state management table 60 stores identifier information 61, state information 62, and callback information 63, with the respective information sets associated with one another.

The identifier information 61 constitutes information for identifying an object to be managed. The identifier information 61 is managed with an ID unique to the information, in association with the state information 62 and the callback information 63 described in the same row of the table in FIG. 5.

The state information 62 stores information representing the state of a predetermined program. The callback information 63 constitutes, for example, information representing a function called for a predetermined program. In the information processing apparatus 1, when the state information 62 of a predetermined program is updated, a function represented by the callback information 63 is called. Then, a variety of processes are performed on the basis of the condition presented by the callback information 63 based on the information stored in the state information 62.

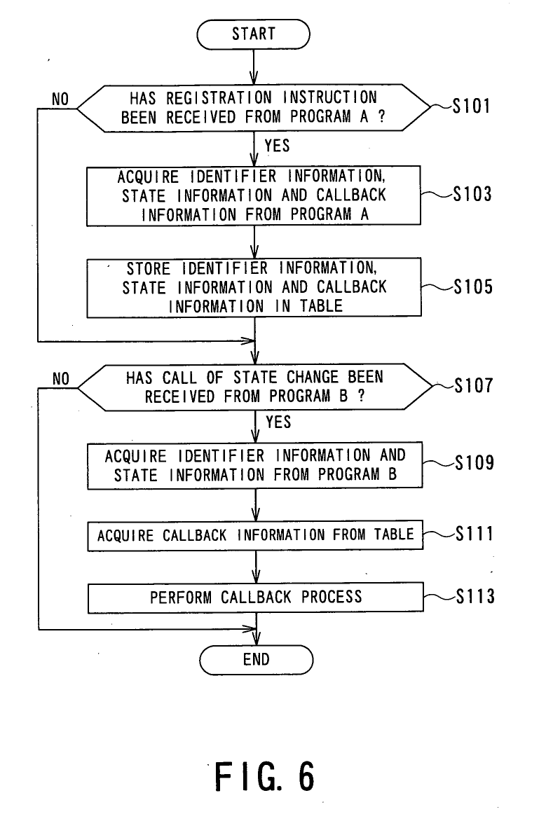

On the basis of the information stored in the state management table 60, the state management unit 46 performs the state management process, which will be described on the basis of a flowchart illustrated in FIG. 6.

The information processing apparatus 1 first performs a registration process of registering the state information 62 representing the state of a program and the callback information 63 corresponding to the state. The state management unit 46 determines whether or not a registration instruction has been received from the program A (Step S101). The registration instruction is issued by, for example, the operation by the user of a predetermined key of the operation keys 24. Then, a callback to the program A called in a predetermined state of the program B is registered. In some cases, the registration process of Step S101 has already been completed in the information processing apparatus 1 at the time of shipment of the apparatus. In such a case, the procedure shifts to “NO” of Step S101. If the registration instruction has not been received (“NO” at Step S101), the state management unit 46 proceeds to Step S107 later described.

If the registration instruction has been received (“YES” at Step S101), the state management unit 46 acquires, from the program A, the identifier information 61 (e.g., “identifier 1”), the state information 62 (e.g., “state 1”), and the callback information 63 (e.g., “callback 1”) (Step S103). The state management unit 46 stores, in the state management table 60, the respective information sets acquired from the program A at Step S103, with the information sets associated with one another (Step S105).

The state management unit 46 determines whether or not a call of a state change has been received from the program B (Step S107). The call of a state change herein refers to the notification to the state management unit 46 of a change in the state of the program B, for example, in the event of the change in the state. If the call of the state change has not been received (“NO” at Step S107), the state management unit 46 completes the state management process.

If the call of the state change has been received (“YES” at Step S107), it is determined that the state of the program B has been changed. Thus, the state management unit 46 acquires the identifier information 61 and the state information 62 from the program B (Step S109). On the basis of the information acquired from the program B at Step S109, the state management unit 46 acquires the callback information 63 for the program A (Step S111). Further, on the basis of the callback information 63, the state management unit 46 causes the program A to perform a callback process (Step S113).

In the above-described manner, when the state of the program B is changed in the information processing apparatus 1, the program A recognizes the state change of the program B and performs the callback process in accordance with the state of the program B. Accordingly, it is possible to cause a plurality of programs, which are supposed to operate independently of one another in a normal situation, to operate in conjunction with one another.

### First Embodiment

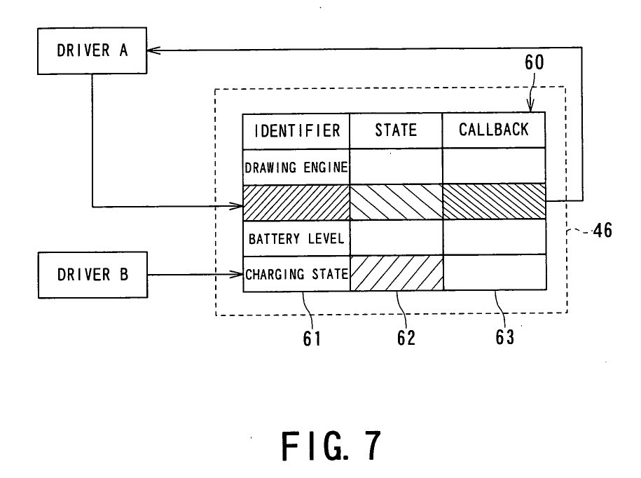

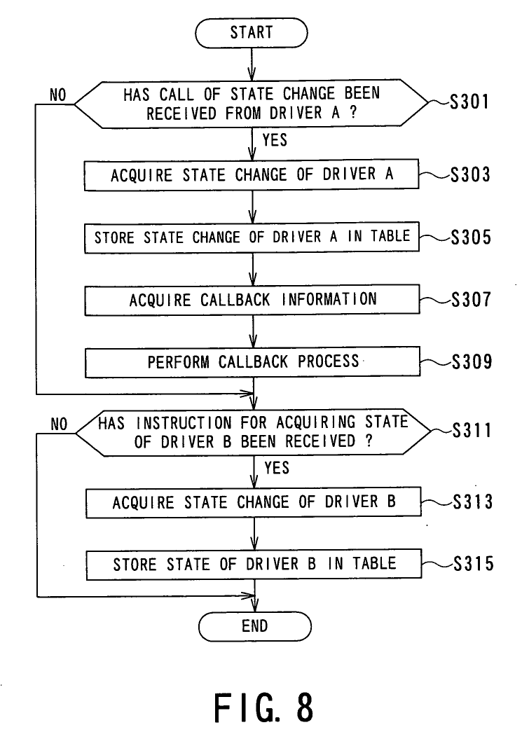

The first embodiment of the information processing apparatus 1 according to the present invention will be described hereunder with reference to FIGS. 7 and 8. As illustrated in FIG. 7, in the first embodiment of the information processing apparatus 1, drivers A and B are connected to the state management unit 46.

As the first embodiment of the information processing apparatus 1, a terminal state monitoring process for monitoring the state of a terminal (a terminal state updating process of updating the state of the terminal and a terminal state acquisition process of acquiring the state of the terminal) will be described with reference to a flowchart illustrated in FIG. 8.

The state management unit 46 determines whether or not a call of a state change has been received from a driver (Step S301). The call of a state change herein refers to the notification by a driver (e.g., the driver A) to the state management unit 46 of a change in the state of the driver, for example, in the event of the change in the state. If the call of the state change has not been received (“NO” at Step S301), the state management unit 46 stands by.

If the call of the state change has been received (“YES” at Step S301), the state management unit 46 acquires the state change of the driver (Step S303). On the basis of the identifier information 61, the state management unit 46 stores, in the state information 62 of the state management table 60, the state change acquired at Step S303 (Step S305).

The state management unit 46 acquires, from the state management table 60, the callback information 63 associated with the identifier information 61 and the state information 62 of the information of the state change acquired at Step S303 (Step S307). Then, on the basis of the callback information 63, the state management unit 46 performs a callback process (Step S309).

When the process of Step S309 is completed, or when the call of the state change has not been received at Step S301 (“NO” at S301), the state management unit 46 determines whether or not an instruction for acquiring the state of a driver (e.g., the driver B) has been received (Step S311). The instruction may be issued through the callback information 63. Further, the instruction may be regularly issued by a timer or may be issued on the basis of an instruction by the user through the operation keys 24. If the instruction for acquiring the state of the driver has not been received (“NO” at Step S311), the state management unit 46 stands by.

If the instruction for acquiring the state of the driver has been received (“YES” at Step S311), the state management unit 46 acquires the information of the state change of the driver (Step S313). Further, on the basis of the identifier information 61, the state management unit 46 stores the information of the state change of the driver in the state management table 60 (Step S315).

The information processing apparatus 1 continuously or regularly performs the processes of the above Steps S301 to S315 to monitor the state of the terminal.

The processes of Steps S301 to S309 constitute the terminal state updating process, and the processes of Steps S311 to S315 constitute the terminal state acquisition process.

### Second Embodiment

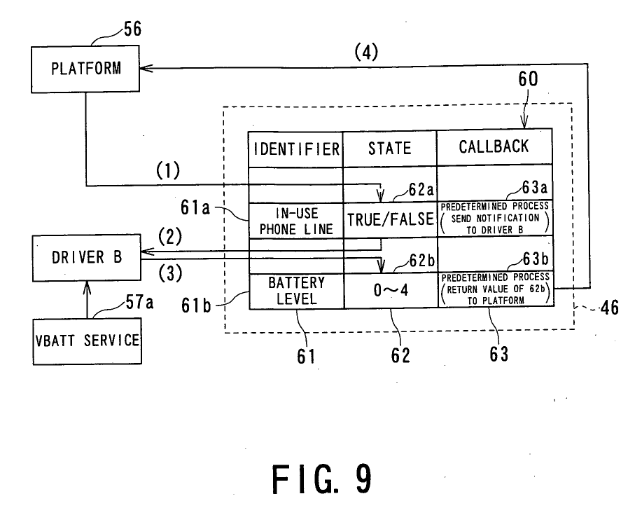

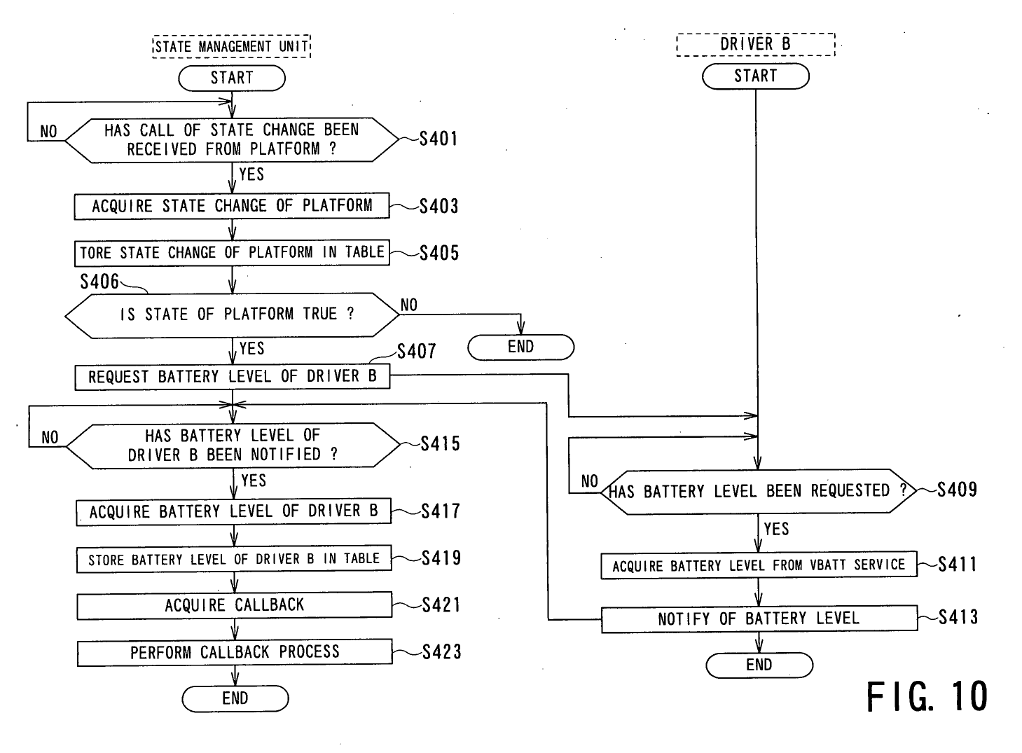

The second embodiment of the information processing apparatus 1 according to the present invention will be described hereunder with reference to FIGS. 9 and 10. As illustrated in FIG. 9, in the second embodiment of the information processing apparatus 1, the state management unit 46 is connected to the platform 56 and the driver B. The driver B is, for example, a driver for the battery of the power supply circuit unit 43.

As the second embodiment of the information processing apparatus 1, a battery level acquisition process for acquiring the battery level of the power supply circuit unit 43, for example, will be described with reference to a flowchart illustrated in FIG. 10. It is herein assumed that an item of “in-use phone line” and an item of “battery level” have been previously described in identifier information 61a and identifier information 61b, respectively. Further, it is assumed that either one of values “TRUE” and “FALSE” and any one of values 1 to 4 have been previously described in state information 62a and state information 62b, respectively. Furthermore, it is assumed that a predetermined process (in the present example, a process of “notifying the driver B of the storage of the value “TRUE” in the state information 62a upon storage of the value”) and a predetermined process (in the present example, a process of “returning the value of the state information 62b to the platform 56 upon update of the state information 62b”) have been previously described in callback information 63a and callback information 63b, respectively.

Each of the identifier information 61a and the identifier information 61b is normally managed with an ID unique to the information. For example, the identifier information 61b is stored with an ID unique to the information and indicating the “battery level,” in association with the state information 62b and the callback information 63b.

The state management unit 46 determines whether or not a call of a state change has been received from the platform 56 (Step S401 and an arrow (1) of FIG. 9). The call of a state change herein refers to the notification by the platform 56 to the state management unit 46 of a change in a predetermined state of the platform 56, for example, in the event of the change in the predetermined state. If the call of the state change has not been received from the platform 56 (“NO” at Step S401), the state management unit 46 stands by.

If the call of the state change has been received from the platform 56 (“YES” at Step S401), the state management unit 46 acquires the information of the state change from the platform 56 (Step S403). On the basis of the identifier information 61, the state management unit 46 stores, in the state information 62a of the state management table 60, the information of the state change acquired at Step S403 (Step S405).

Since the state information 62a has been newly updated, the state management unit 46, which has acquired the information of the state change, performs the process described in the callback information 63a corresponding to the state information 62a. Specifically, the state management unit 46 determines whether or not the value “TRUE” is stored in the state information 62a. Then, if the state information 62a is determined to store the value “TRUE” (“YES” at Step S406), the state management unit 46 notifies the driver B of the value, and requests the driver B for the reading of the battery level (Step S407 and an arrow (2) of FIG. 9). If not, the process by the state management unit 46 is completed.

The driver B determines whether or not the request for the battery level has been received (Step S409). If the request for the battery level has been received (“YES” at Step S409), the driver B causes the battery service (the VBATT service 57a) to measure the battery level, and acquires the information of the battery level from the battery service (Step S411). Thereafter, the driver B notifies the state management unit 46 of the battery level acquired at Step S411 (Step S413 and an arrow (3) of FIG. 9).

The state management unit 46 determines whether or not the battery level has been notified by the driver B (Step S415). If the battery level has not been notified by the driver B (“NO” at Step S415), the state management unit 46 stands by.

If the battery level has been notified by the driver B (“YES” at Step S415), the state management unit 46 acquires the information of the battery level from the driver B (Step S417). The state management unit 46 stores in the state information 62b the state of the battery level acquired at Step S417 (Step S419).

The state management information 46 acquires, from the state management table 60, the callback information 63b corresponding to the information of the battery level acquired at Step S417 (Step S421). The state management unit 46 calls the callback information acquired at Step S421 and performs a callback process (Step S423 and an arrow (4) of FIG. 9). As the callback process performed in this case, the state management unit 46 performs, for example, a battery level notification process of notifying to the LCD control unit 45 of the platform 56 of the battery level stored in the state information 62b to change the display of the battery level on the liquid crystal display 25.

In the above-described manner, the information processing apparatus 1 performs the battery level acquisition process. In the above description, the identifier information 61, the state information 62, and the callback information 63 include two groups (a group of the information sets 61a, 62a, and 63a, and a group of the information sets 61b, 62b, and 63b), as an example. Needless to say, however, the groups of information are not limited thereto, and thus, another group of information may be registered in the state management table 60.

### Third Embodiment

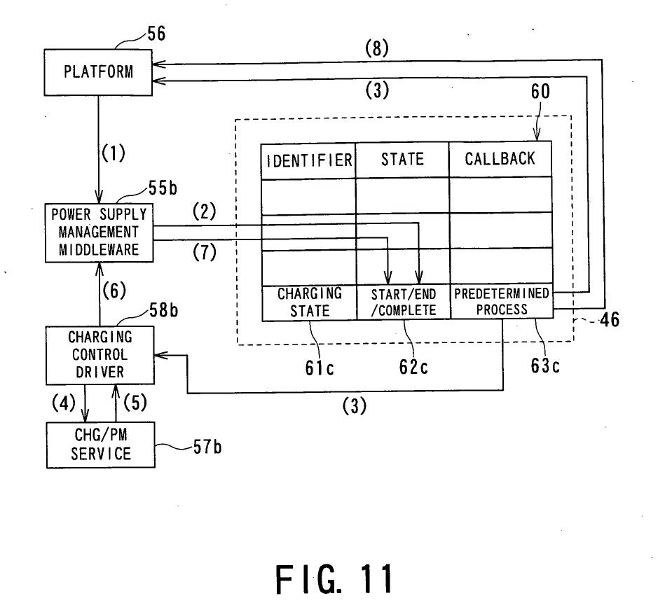

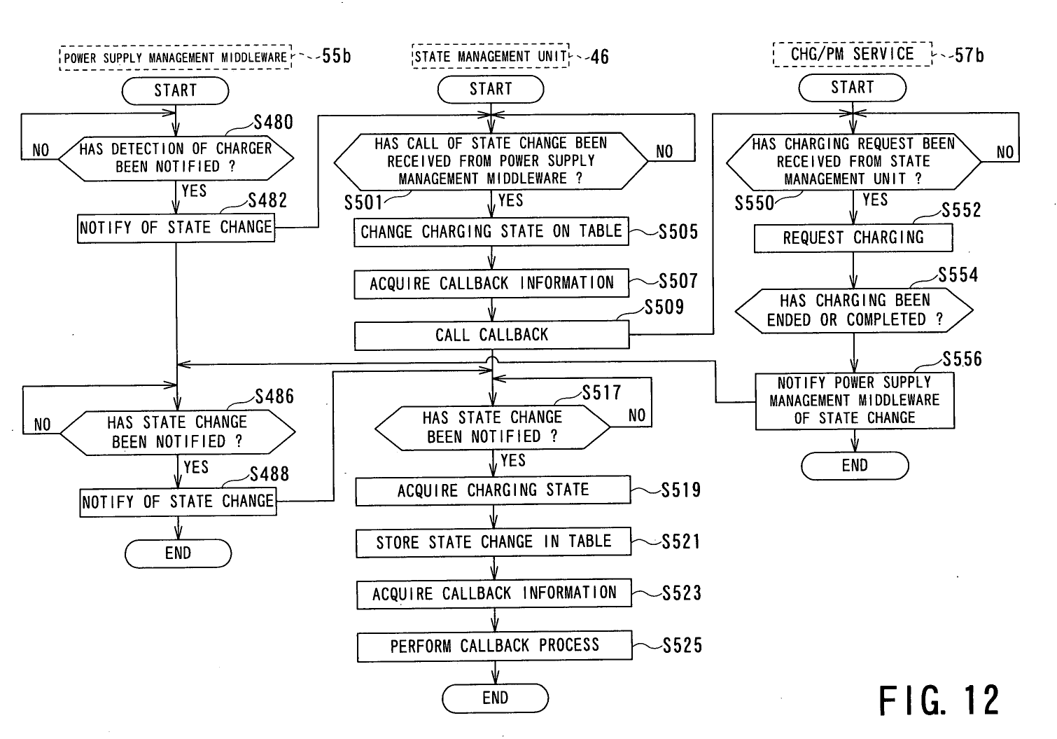

The third embodiment of the information processing apparatus 1 according to the present invention will be described hereunder with reference to FIGS. 11 and 12. As illustrated in FIG. 11, in the third embodiment of the information processing apparatus 1, the state management unit 46 is connected to the platform 56 and the charging control driver 58b. The charging control driver 58b is, for example, a driver for the battery of the power supply circuit unit 43. It is herein assumed that an item of “charging state” and any one of values “START”, “END”, and “COMPLETE” have been previously described in identifier information 61c and state information 62c, respectively. Further, it is assumed that a predetermined process (in the present example, a process of “requesting the charging control driver 58b to perform the charging upon storage of the value “START” in the state information 62c and notifying the platform 56 of the start of the charging, and notifying the platform 56 of the end or completion of the charging upon storage of the value “END” or “COMPLETE” in the state information 62c”) has been previously described in the callback information 63c.

The identifier information 61c is normally managed with an ID unique to the information. For example, the identifier information 61c is stored with an ID unique to the information and indicating the “charging state”, in association with the state information 62c and the callback information 63c.

As the third embodiment of the information processing apparatus 1, a charging control process for controlling the charging of the battery of the power supply circuit unit 43, for example, will be described with reference to a flowchart illustrated in FIG. 12. Upon detection of the connection of a not-illustrated device driver of the information processing apparatus (the mobile phone device) 1 to a charger, the platform 56 notifies the power supply management middleware 55b of the detection of the connection to the charger (an arrow (1) of FIG. 11).

The power supply management middleware 55b first determines whether or not the detection of the connection to the charger has been notified (Step S480). If the detection of the connection to the charger has not been notified (“NO” at Step S480), the power supply management middleware 55b stands by. If the detection of the connection to the charger has been notified (“YES” at Step S480), the power supply management middleware 55b notifies the state management unit 46 of the start of the charging in accordance with the detection of the connection to the charger (Step S482 and an arrow (2) of FIG. 11).

Meanwhile, the state management unit 46 determines whether or not a call has been received from the power supply management middleware 55b (Step S501). Then, if it is determined that the call has not been received (“NO” at Step S501), the state management unit 46 returns again to Step S501. If it is determined that the call has been received from the power supply management middleware 55b (“YES” at Step S501), the state management unit 46 changes the charging state to the value “START” in the state management table 60 (Step S505).

The state management unit 46 acquires, from the state management table 60, the callback information 63c associated with the charging state changed at Step S505 (Step S507). The state management unit 46 calls a callback and performs the process of the callback (Step S509). As the process of the callback performed in this case, the state management unit 46 performs, for example, a charging state notification process of notifying the platform 56 of the start of the charging and notifying the LCD control unit 45 of the charging state to change the display of the charging state on the liquid crystal display 25. Further, the state management unit 46 instructs the charging control driver 58b to start the charging (arrows (3) of FIG. 11).

Meanwhile, the charging control driver 58b determines whether or not the request for the charging start instruction made by the state management unit 46 at Step S509 has been received (Step S550). Then, if it is determined that the request has not been received (“NO” at Step S550), the charging control driver 58b returns again to Step S550. If the request for the charging start instruction has been received from the state management unit 46, the charging control driver 58b requests the CHG/PM service 57b to start the charging and a control operation accompanying the charging (Step S552 and an arrow (4) of FIG. 11). Thereafter, the charging control driver 58b determines whether or not the end or completion of the charging has been notified by the CHG/PM service 57b (Step S554). Then, if it is determined that the end or completion of the charging has not been notified (“NO” at Step S554), the charging control driver 58b returns to Step S554. If it is determined that the end or completion of the charging has been notified (“YES” at Step S554 and an arrow (5) of FIG. 11), the charging control driver 58b notifies the power supply management middleware 55b of the end or completion of the charging (Step S556 and an arrow (6) of FIG. 11), and completes the procedure.

Then, at Step S486, the power supply management middleware 55b determines whether or not the state change has been notified (whether or not the end or completion of the charging has been notified) by the charging control driver 58b (Step S486). Then, if it is determined that the state change has not been notified (“NO” at Step S486), the power supply management middleware 55b returns again to Step S486. If it is determined that the state change has been notified (“YES” at Step S486), the power supply management middleware 55b notifies the state management unit 46 of the state change (the notification of the end or completion of the charging) (Step S488 and an arrow (7) of FIG. 11).

Meanwhile, the state management unit 46 determines whether or not the state change has been notified by the power supply management middleware 55b (Step S517). If the state change has not been notified (“NO” at Step S517), the state management unit 46 stands by.

If the state change has been notified (“YES” at Step S517), the state management unit 46 acquires state change information from the power supply management middleware 55b (Step S519). The state management unit 46 stores, in the state information 62c of the state management table 60, the state change information acquired at Step S519 (Step S521).

Then, on the basis of the state information 62c acquired at Step S519, the state management unit 46 acquires the corresponding callback information 63c from the state management table 60 (Step S523). The state management unit 46 then calls the callback information 63c and performs a callback process (Step S525). As the callback process performed in this case, the state management unit 46 performs, for example, a charging state notification process of notifying the platform 56 of the end or completion of the charging to change the display of the charging state (from a charging icon to a normal icon representing the remaining battery charge) on the liquid crystal display 25 (an arrow (8) of FIG. 11). In the above-described manner, the charging control process is performed in the information processing apparatus 1.

The method of storing the information performed by the state management unit 46 is not limited to the method described above. In the embodiment described above, one group of information is stored, as an example. Needless to say, however, another group of information may be registered in the state management table 60 in addition to the one group of information.

### Fourth Embodiment

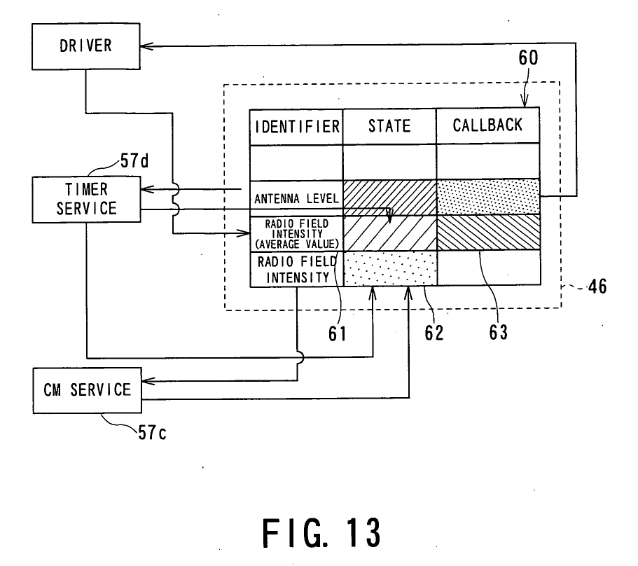

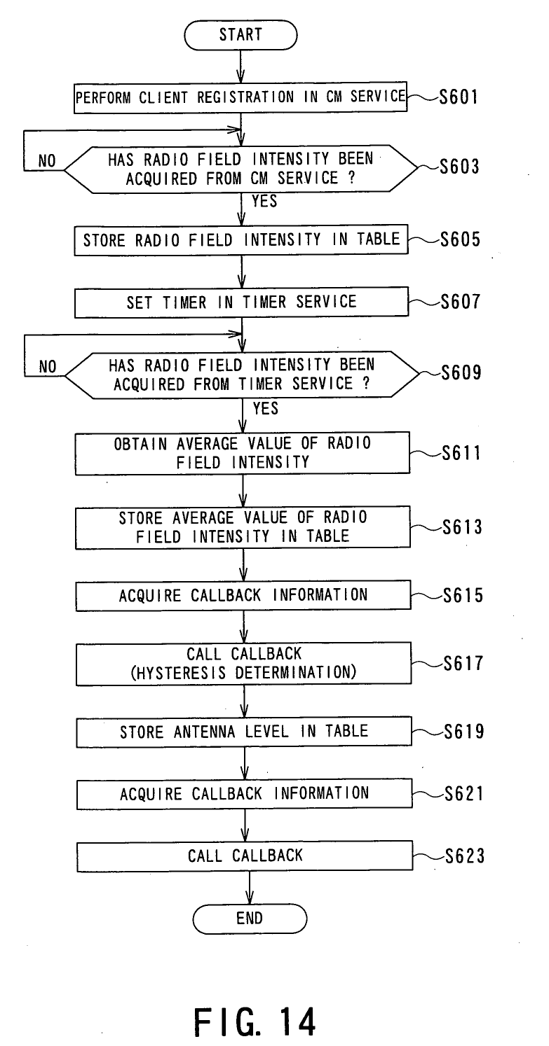

The fourth embodiment of the information processing apparatus 1 according to the present invention will be described hereunder with reference to FIGS. 13 and 14. As illustrated in FIG. 13, in the fourth embodiment of the information processing apparatus 1, the state management unit 46 is connected to the TIMER service 57d and the CM service 57c.

As for the antenna level of the information processing apparatus 1, the radio field intensity can be regularly notified, if the platform, for example, is registered as a client in the CM service 57c (a service for measuring the radio wave level). The conversion from the radio field intensity to the antenna level is performed by an application.

In the information processing apparatus 1, the radio field intensity and the antenna level are prepared to represent the terminal state. The radio field intensity is regularly acquired by a timer and set as the terminal state. In this process, if there is a change from the last acquired value, a hysteresis determination is performed in a registered callback to determine the antenna level. Then, if the antenna level has been changed, the change is notified to a specified module by the callback of the antenna level.

As the fourth embodiment of the information processing apparatus 1, an antenna level monitoring process for monitoring the antenna level will be described with reference to a flowchart illustrated in FIG. 14.

The state management unit 46 first performs the client registration in the CM service 57c (Step S601). The state management unit 46 then determines whether or not the information of the radio field intensity has been acquired from the CM service 57c (Step S603). If the information of the radio field intensity has not been acquired (“NO” at Step S603), the state management unit 46 stands by.

If the information of the radio field intensity has been acquired (“YES” at Step S603), the state management unit 46 stores the radio field intensity in the state management table 60 (Step S605). Further, the state management unit 46 sets a timer in the TIMER service 57d (Step S607). In this case, the timer time has been previously kept by the state management unit 46.

The state management unit 46 determines whether or not the radio field intensity has been acquired from the TIMER service 57d (Step S609). On the basis of the timer time set at Step S607, the TIMER service 57d notifies the state management unit 46 of the radio field intensity. If the radio field intensity has not been acquired from the TIMER service 57d (“NO” at Step S609), the state management unit 46 stands by.

If the radio field intensity has been acquired from the TIMER service 57d (“YES” at Step S609), the state management unit 46 obtains the average value of the radio field intensity (Step S611). The average value can be obtained by additional averaging, for example. The state management unit 46 stores, in the state management table 60, the average value of the radio field intensity obtained at Step S611 (Step S613).

The state management unit 46 acquires from the state management table 60 the callback information 63 associated with the average value of the radio field intensity stored at Step S613 (Step S615).

On the basis of the callback information 63 acquired at Step S615, the state management unit 46 calls a callback (Step S617). As the callback process performed in this case, the state management unit 46 performs, for example, a hysteresis determination of making a determination with the use of separate values of the upper limit and the lower limit of the radio field intensity to thereby acquire the antenna level.

In the hysteresis determination, the antenna level is assumed to vary only by ±1 at a maximum. Further, the radio filed intensity is constantly calculated for both of a 1× and an HDR. Normally, the antenna level is calculated from the average value of the radio field intensity of the 1×. During the data communication, however, the antenna level is calculated from the radio field intensity of the HDR.

The state management unit 46 stores the antenna level acquired at Step S617 in the state management table 60 at a predetermined position in the table (in association with an identifier “antenna level,” for example), to thereby set the antenna level (Step S619). The state management unit 46 then acquires the callback information 63 associated with the antenna level stored at Step S619 (Step S621). On the basis of the callback information 63 acquired at Step S621, the state management unit 46 calls a callback (Step S623). In the above-described manner, the information processing apparatus 1 performs the antenna level monitoring process.

### Fifth Embodiment

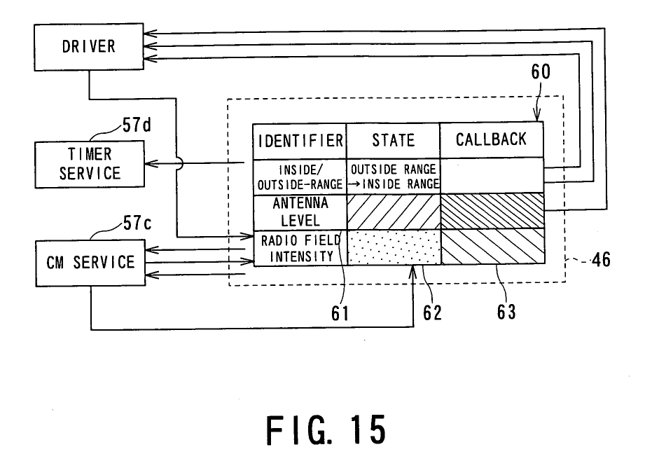

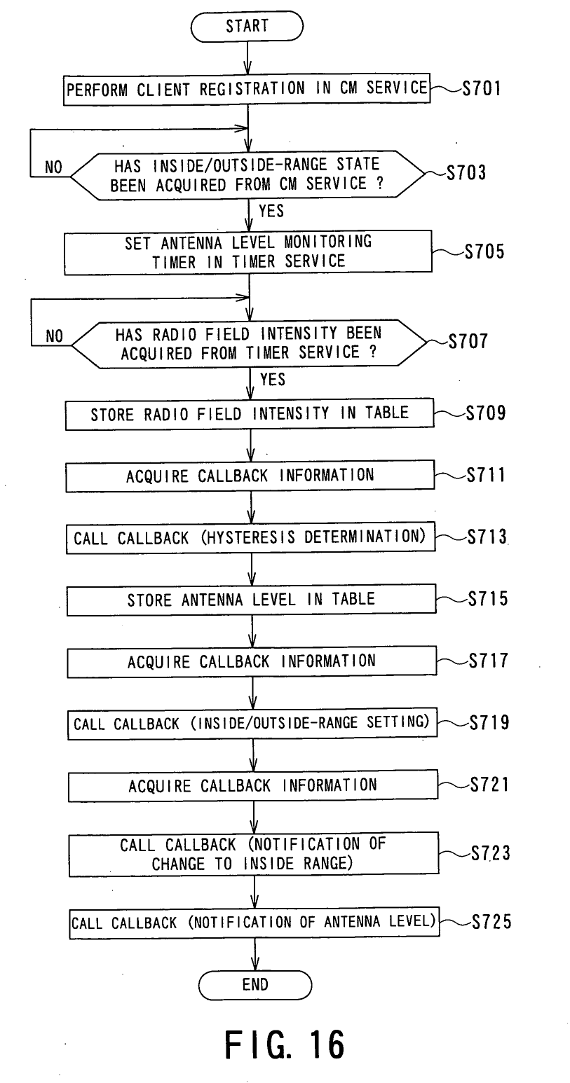

The fifth embodiment of the information processing apparatus 1 according to the present invention will be described hereunder with reference to FIGS. 15 and 16. As illustrated in FIG. 15, in the fifth embodiment of the information processing apparatus 1, the state management unit 46 is connected to the TIMER service 57d and the CM service 57c.

In the information processing apparatus 1, an inside/outside-range state is prepared to represent the terminal state. Due to the client registration in the CM service 57d, the inside/outside-range state is notified by the CM service 57c in the event of a change in the inside/outside-range state, and thus, is set in the terminal state. In this process, if there is a change from the last inside/outside-range state, the change is notified to a specified module in a registered callback.

In the shift from an outside-range state to an inside-range state, the antenna level needs to be acquired. Thus, upon notification of the inside-range state, the radio filed intensity is first acquired, and the antenna level is calculated by a mechanism similar to the antenna monitoring function. Thereafter, the inside/outside-range state is set in the callback of the antenna level.

As the fifth embodiment of the information processing apparatus 1, an inside/outside-range state monitoring process for monitoring the inside/outside-range state will be described with reference to a flowchart illustrated in FIG. 16.

The state management unit 46 first performs the client registration in the CM service 57c (Step S701). After the client registration, the state management unit 46 determines whether or not the inside/outside-range state has been acquired from the CM service 57c (Step S703). If the inside/outside-range state has not been acquired (“NO” at Step S703), the state management unit 46 stands by.

If the inside/outside-range state has been acquired (“YES” at Step S703), the state management unit 46 sets an antenna level monitoring timer in the TIMER service 57d (Step S705). In this case, the timer time has been previously kept by the state management unit 46. The inside/outside-range state in the present example is assumed to be the inside-range state.

The state management unit 46 determines whether or not the radio field intensity has been acquired from the TIMER service 57d (Step S707). If the radio field intensity has not been acquired (“NO” at Step S707), the state management unit 46 stands by.

If the radio field intensity has been acquired (“YES” at Step S707), the state management unit 46 stores the acquired the radio field intensity in the state management table 60 (Step S709). Further, the state management unit 46 acquires the callback information 63 associated with the radio field intensity acquired at Step S707 (Step S711).

In a similar manner as in the process of Step S617 of the fourth embodiment, the state management unit 46 calls a callback and performs a hysteresis determination to acquire the antenna level (Step S713). Further, the state management unit 46 stores, in the state management table 60, the antenna level acquired at Step S713 to thereby set the antenna level acquired at Step S713 (Step S715). The state management unit 46 acquires, from the state management table 60, the callback information 63 associated with the antenna level (Step S717).

On the basis of the callback information 63 acquired at Step S717, the state management unit 46 calls a callback (Step S719). In this process, the state management unit 46 stores in the state management table 60 the inside/outside-range state acquired at Step S703, for example, to thereby set the inside/outside-range state. The state management unit 46 acquires, from the state management table 60, the callback information 63 associated with the inside/outside-range state (Step S721).

On the basis of the callback information 63 acquired at Step S721, the state management unit 46 calls a callback (Step S723). As the process of the callback performed in this case, the state management unit 46 performs, for example, a change-to-inside-range notification process of notifying the LCD control unit 45 of the change of the inside/outside-range state to the inside-range state to change the display of the inside/outside-range state on the liquid crystal display 25.

Further, on the basis of the callback information 63 acquired at Step S721, the state management unit 46 calls another callback (Step S725). As the process of the callback performed in this case, the state management unit 46 performs, for example, an antenna level notification process of notifying the LCD control unit 45 of the antenna level to change the display of the antenna level on the liquid crystal display 25.

In the above-described manner, the information processing apparatus 1 performs the inside/outside-range state monitoring process.

### Sixth Embodiment

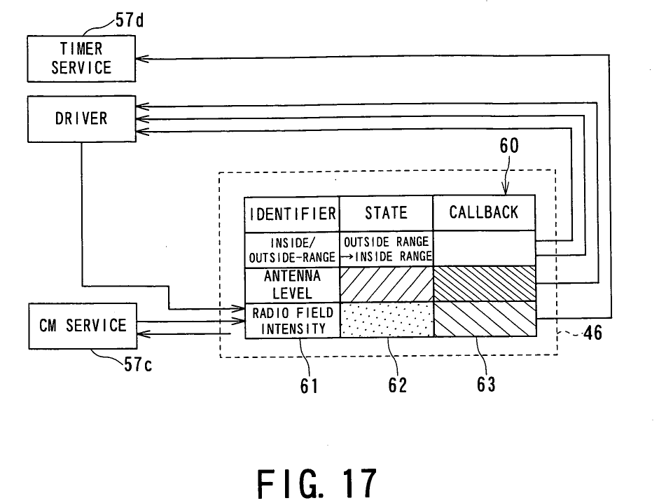

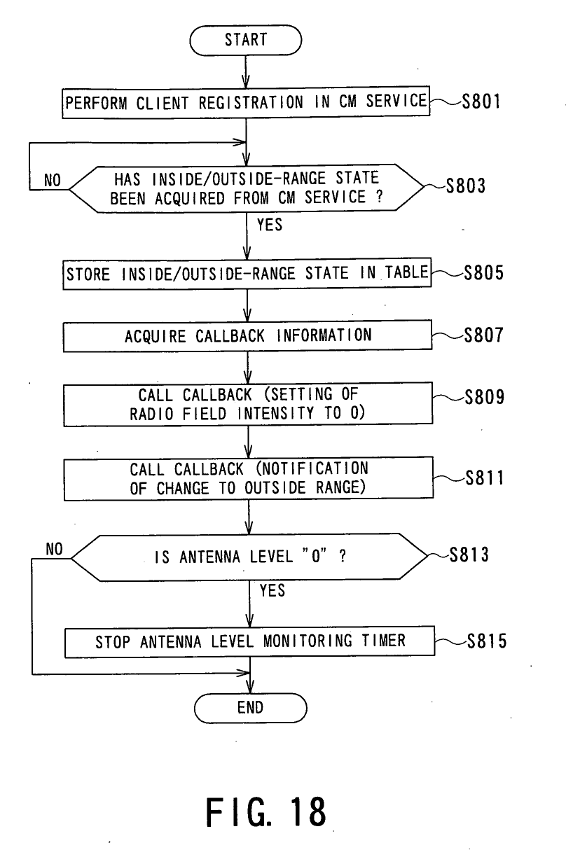

The sixth embodiment of the information processing apparatus 1 according to the present invention will be described hereunder with reference to FIGS. 17 and 18.

As illustrated in FIG. 17, in the sixth embodiment of the information processing apparatus 1, the state management unit 46 is connected to the TIMER service 57d and the CM service 57c.

In the information processing apparatus 1, when the 1× indicates the outside-range state and the HDR indicates the inside-range state, inside/outside-range information indicates the outside-range state, since the information of the 1× is normally set in the inside/outside-range information. However, as a special condition for the outside-range state, the state of the HDR needs to be set in the inside/outside-range information only at the start of the data communication. That is, it is necessary to set the inside/outside-range information to the inside-range state and to set the radio field intensity to the radio field intensity of the HDR. At the start of the data communication outside the range, the inside/outside-range state can be acquired from the CM service 57c. Thus, the information processing apparatus 1 functions in a sequence of processes similar to the sequence of processes performed in the shift from the outside-range state to the inside-range state.

As the sixth embodiment of the information processing apparatus 1, an inside/outside-range state monitoring process for monitoring the inside/outside-range state will be described with reference to a flowchart illustrated in FIG. 18.

The state management unit 46 first performs the client registration in the CM service 57c (Step S801). After the client registration, the state management unit 46 determines whether or not the inside/outside-range state has been acquired from the CM service 57c (Step S803). If the inside/outside-range state has not been acquired (“NO” at Step S803), the state management unit 46 stands by.

If the inside/outside-range state has been acquired (“YES” at Step S803), the state management unit 46 stores, in the state management table 60, the inside/outside-range state acquired at Step S803 (Step S805). The inside/outside-range state in the present example is assumed to be the outside-range state. Further, the state management unit 46 acquires, from the state management table 60, the callback information 63 associated with the inside/outside-range state (Step S807).

On the basis of the callback information 63 acquired at Step S807, the state management unit 46 calls a callback (Step S809). In this process, the state management unit 46 stores the value “0”, for example, in the state management table 60 as the radio field intensity to thereby set the radio field intensity to be zero.

Further, on the basis of the callback information 63 acquired at Step S807, the state management unit 46 calls another callback (Step S811). As the process of the callback performed in this case, the state management unit 46 performs, for example, a change-to-outside-range notification process of notifying the LCD control unit 45 of the change of the inside/outside-range state to the outside-range state to change the display of the inside/outside-range state on the liquid crystal display 25.

Then, the state management unit 46 determines whether or not the antenna level is zero (Step S813). The antenna level is reduced by one phase at every timeout of the timer in the TIMER service 57d. Only when the antenna level is zero (“YES” at Step S813), the state management unit 46 stops the antenna level monitoring timer set at Step S705 of the fifth embodiment (Step S815). In the above-described manner, the information processing apparatus 1 performs the inside/outside-range state monitoring process.

The processes of Steps S101 to S105 constitute a storage unit, and the process of Step S107 constitutes a detection unit. Further, the processes of Steps S109 and S111 constitute an acquisition unit, and the process of Step S113 constitutes an execution unit.

In the first embodiment, the description has been made of the information processing apparatus 1 of the mobile phone type. The information processing apparatus 1, however, is not limited thereto, and thus may be an arbitrary information terminal such as a PDA (Personal Digital Assistant).

What is claimed is:

1. An information processing apparatus for executing a plurality of programs comprising:
a storage unit configured to store a state information set by a first program and a callback information set by a second program, with the state information and the callback information associated with each other;
a detection unit configured to detect a change in the state information set by the first program;
an acquisition unit configured to acquire the callback information set by the second program if the detection unit detects the change in the state information set by the first program; and
an execution unit configured to call a callback on the basis of the callback information acquired by the acquisition unit.

2. The information processing apparatus according to claim 1, wherein a group including the mutually associated state information and callback information is managed with an ID unique to the group, and information of a plurality of groups is stored by the storage unit.

3. The information processing apparatus according to claim 1, wherein the storage unit is configured to store a battery level information as the state information and to store a program for notifying of a battery level as the callback information, and the execution unit is configured to notify the battery level on the basis of the callback information.

4. The information processing apparatus according to claim 1, wherein the storage unit is configured to store charging start information as the state information and to store a program for performing a charging process as the callback information, and the execution unit is configured to perform the charging process on the basis of the callback information.

5. The information processing apparatus according to claim 1, wherein the storage unit is configured to store radio field intensity information for communication as the state information and to store a program for calculating an antenna level as the callback information, and the execution unit is configured to calculate the antenna level on the basis of the callback information.
